(19) United States
(12) Patent Application Publication
(10) Pub. No.: US 2017/0353558 A1
(43) Pub. Date: Dec. 7, 2017

(54) DEVICE FOR USE IN A DYNAMIC NETWORK, AND DYNAMIC NETWORK

(71) Applicant: Christopher Bentley, Gremsdorf (DE)

(72) Inventor: Christopher Bentley, Gremsdorf (DE)

(21) Appl. No.: 15/539,162

(22) PCT Filed: Dec. 23, 2015
(86) PCT No.: PCT/DE2015/000604

§ 371 Date: Jun. 23, 2017

(30) Foreign Application Priority Data
Dec. 24, 2014 (DE) 10 2014 019 534.1

(51) Int. Cl. H04L 29/08; H04L 29/06; H04L 12/24

(52) U.S. Cl. CPC H04L 67/125; H04L 67/1065; H04L 41/12; H04L 63/0442

(57) ABSTRACT

The invention relates to embodiments of a device for use in a dynamic network. Said device (100) comprises a network interface (102) for integration into an overlay network topology. A data processing unit (104) is connected to the network interface (102) and is designed to transmit and/or receive data via the network interface (102). A functional unit (106) is coupled to the data processing unit (104).

The present disclosure relates to a device, in particular it relates to a device for use in a dynamic network, as well as to a dynamic network.

With the emergence and development of an internet of things (IoT) it is required to connect different devices to form a common network. Within in the IoT, it will be necessary to connect a first device, such as a smartphone or a switch, to a second device, such as a window blind in such a manner, that the second device is controlled in either a status of the first device, by a signal of the first device or by influence of any other component of the IoT, without requiring a user intervention.

At present, different providers tender various systems in relation to the emerging IoT, which should support the formation of such an internet of things. In most cases, such networks are set up hierarchically and are controlled via a central server or by cloud services. This results in lack of compatibility between systems and in additional effort when establishing or converting an IoT network structure.

One objective of the present invention is to provide for a device for use in a dynamic network, as well for to a dynamic network that allow to ingrate a device into an existing IoT network. It is a further objective to allow for modifications of the device's function and interaction with other elements or component of the IoT network at any time and by an element of the network.

The objectives are achieved by a device according to claim 1. Various aspects and further developments of the device are specified in the dependent claims.

EXEMPLARY EMBODIMENTS

Various embodiments of the device have a network interface to connect to an overlay network topology. A data processing unit connects to the network interface, the data processing unit being configured to send and/or receive data via the network interface. A functional unit connects to data processing unit.

In various embodiments, the network interface is configured to connect via a wireline or wireless communication network. The wireline communication networks may be based on an internet protocol, such as TCP/IP or DP. They may use data transmission via electrical or optical media, such as copper wires or optical fibers. In a wireless communication network, data are transmitted via electromagnetic waves, such as radio or infrared signals. Wireless communication networks make use of standards and related protocols, such as EnOcean, Z-Wave, Zigbee, Bluetooth, WLAN, IrDA, etc.

The network interface may be configured to connect to the dynamic network via one or multiple different wireline or wireless communication protocols. In consequence, the device may be part of different physical networks. It is as well possible, that the device will form an inter-link between networks, which are based on different communication protocols.

An essential function of the network interface is the connection to the overlay network topology. The overlay network topology is a network topology created by an addressing on the physical networks formed by communication protocols, which addressing does allow for a logic network structure. In the following, the overlay network topology may be understood as a network topology allowing for a routing procedure for enabling communication between network elements, e.g. communication between devices as described in the present disclosure. Examples for such an overlay network topology are:
Content Addressable Network (CAN)
Chord
DiffSerV
Gnutella
And as preferred embodiment
Kademlia.
   Many other beneficial and suitable overlay network topologies are available to the person skilled in the art for selection or combination upon purpose.

The preferred embodiment making use of a Kademlia network topology bases on a HASH table distributed among network elements. Information on the logic network is stored in the HASH table. A unique identifier (Node-ID) identifies each component of the Kademlia network topology. The node ID is not only representative for the identification of the element. It further allows for distributing network information on the distributed HASH table. As consequence, new elements may be inserted to the logic network, and the element inserted in a logic position in the network as expected by all elements of the network, even if their portion of the HASH table has not yet received an update. To that end, the insertion of the new element follows a bootstrapping procedure, by which the new element identifies some elements of the existing network in a first step and receives information on other elements of the network by those identified elements afterwards. With this information, the new element identifies the network topology of the existing network. This allows for a very fast formation of a huge and real peer-to-peer network.

The data processing unit enables the sending and receiving of data via the network interface. In various embodiments, the data processing performs various and diverse functions of the device within a dynamic network. It is possible, that the data processing unit provides data, which may be provided to other elements of the dynamic network (publish function). In addition or as alternative to that, the data processing unit may serve to capture data of other elements of the network and to utilize the captured data for the device's function (subscribe function). In other embodiments or further developments of the data processing unit, these may serve to image the function of specific elements of the dynamic network by means of a data model (clone function) and to provide for inter-links between elements in said data model, to erase existing inter-links or to adapt these (modelling function). In some embodiments of the data processing unit, the data processing unit is adapted to change the function of the device based on data received (update function). In addition or as alternative to that, the data processing unit may execute a function by which another device of the dynamic network is directly controlled, whether in all or in parts of its functionality. In such a case, the use of the clone function, the modelling function and the update function is obsolete. The other device becomes an avatar and is controlled by the data processing unit. If the data processing unit provides for all described functions, it is enabled, to form, expand, shape and control the dynamic network.

In an embodiment of the device, the data processing unit is configured to receive and/or emit data via an observation pattern. The data processing unit provides for as well for a publish function as well as for a subscribe function. The observation pattern may therefore be described as a publish/subscribe method. The publish/subscribe method is particularly advantageous, since communication within in the dynamic network is reduced to the necessary minimum. This is achieved by the following: In a first step, all network elements page their interest to a specific set of supplied data of a specific network element or subject (subscribe). They thus turn into an observer role. The supplied data may be retrieved. The subject publishes all change in value or status of the supplied data via the network (publish).

The function unit of the device executes the actual function of the device. In one embodiment, the functional unit may comprise an actuator and/or a sensor. To name some examples, the functional unit may comprise e.g., a light source, an engine, a valve, a switch, a signal processor or any other active device (actuator). In addition or as alternative, the functional unit may comprise e.g., a camera, a detector, a thermometer, or any other active or passive unit alike to sense a particular physical or chemical property or condition.

In one embodiment of the device, the data processing unit is configured to regulate and control the functional unit. In consequence, the functional unit may by regulated and controlled in dependence of data received or derived by the data processing unit from the dynamic network. E.g., an actuator provided for in the functional unit may be activated or de-activated accordingly. In another example, the sensitivity of a sensor provided for in the functional unit may be accordingly adapted.

In an embodiment of the device, the data processing unit is configured to receive data from the functional unit. The data processing unit may thus publish data within the dynamic network, which data represent information on a state of the functional unit. E.g., information on an actuator may be published in the dynamic network, e.g. information on a switching state of a switch or in a level of activation of an actuator, such as information on a position of a shaft of a servo motor.

In an embodiment of the device, the functional unit comprises a data generation unit. The data generation unit may be a digital signal processor, e.g. for generating a data stream, such as for generating a sequence of (Pseudo-) random numbers. It as well possible, that the data generation unit generates a time or clock signal. These signals may be published via the data generation unit into the dynamic network and may serve inter alia to control or switch communication within the dynamic network.

In one embodiment of the device, the functional unit comprises a man-machine interface. This allows for publishing user data captured by the man-machine interface within the dynamic network. In result, the device to thus configured to allow a user to actively manipulate the dynamic network, e.g. for administration, observation and/or enlargement of the later.

The disclosed dynamic network comprises a first device according to the invention and a second device according to the invention.

In a further arrangement of the dynamic network, the second device comprises an actuator unit, which may be activated by a date received from the first device, which date indicates a change of state. This embodiment is a simple form of a dynamic network, in which the second device observes at least one date of the first device and in which a change of state of said data controls the second device.

In one embodiment of the dynamic network, it comprises a third device, whereby the third device is configured to transmit from the first device to the second device an alteration date indicating a change of state. The third device functions as a repeater within the dynamic network. This function may be achieved by having the third device observing a date of the first device and by having the third device to republish said data, thus making the date available to any device that may not observe the date publication of the first device directly or physically. This allows for spreading the network over large distances, in particular the physical extent of the network is enlarged importantly. This is of particular advantage, when the dynamic network makes use of any communication standard with low ranging, such as Bluetooth.

The third device may as well be configured to communicate to the first device by a first communication standard and to communicate to the second device by a second communication standard distinct from the first communication standard. The third device thus serves as a bridge or gateway between different communication standards.

In yet another embodiment of the dynamic network, data communication between the first device and the second device is encrypted by an asymmetrical encryption method.

### SHORT DESCRIPTION OF THE DRAWINGS

Divers embodiments of the device and of the dynamic network are described with reference to the accompanying figures. In the figures, the left most digits of a reference number identify the figure in which the reference number first appears. The use of the same reference number in different instances in the description and the figure indicate similar or identical items.

FIG. 1 shows a schematic representation of a first embodiment of the device for use in a dynamic network;

FIG. 2a shows a schematic representation of the physical structure of an embodiment of the dynamic network;

FIG. 2b shows a schematic representation of the overlay structure of an embodiment of the dynamic network;

FIG. 3 shows a schematic representation of a communication process between devices of a dynamic network;

FIG. 4 shows a schematic representation of an embodiment of a user interface on a man-machine interface for creation installation and management of interlinks in a dynamic network;

FIG. 5 shows a schematic representation of method for certification of a communication between two devices for use in dynamic network.

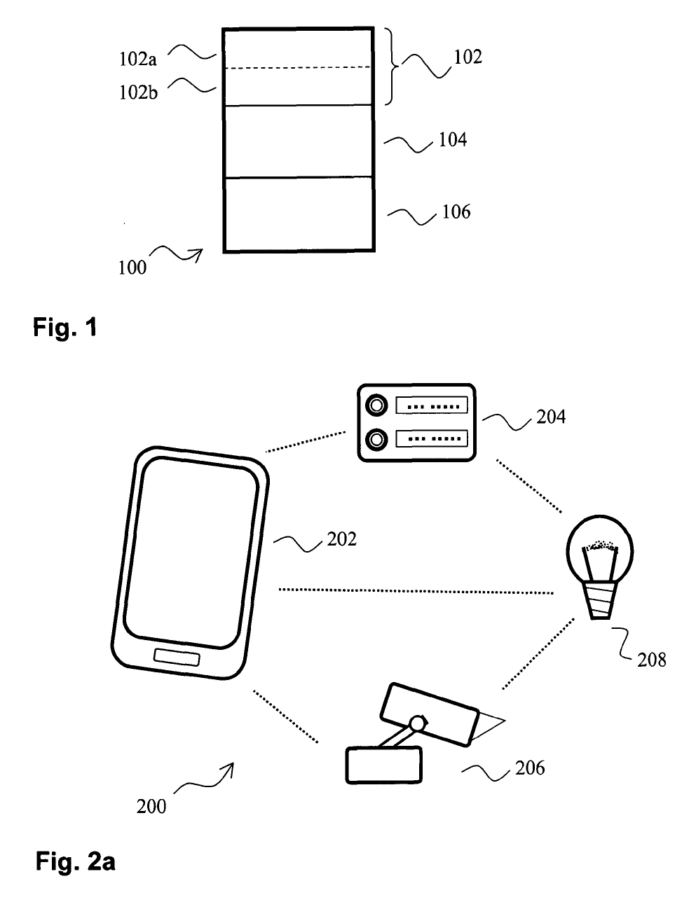

FIG. 1 shows a schematic representation of a first embodiment of the device for use in a dynamic network. The device 100 has a network interface 102 to connect to an overlay network topology. The network interface connects to data processing unit 104, which data processing unit 104 is adapted to send and/or receive data via the network interface 102. The data processing unit 104 connects to a functional unit 106.

The network interface 102 has a physical interface to connect the device into a communication network. The physical interface may comprise a transmitter as well as an air interface, e.g. an antenna, or a wireline interface, e.g. a connecting terminal, e.g. an optical coupler or a USB terminal, etc. A physical connection to the communication network is established via the physical interface. In most cases, the network interface further comprises a digital signal processor, by which the device processes received or transmitted data. The digital signal processor is configured to perform all signal processing required within the physical layer and a possible medium access layer in line with the communication standard used.

Network interface further comprises a processing unit to connect the device in an overlay network topology. The overlay network topology is a network topology created by an addressing on the physical networks formed by communication protocols, which addressing does allow for a logic network structure. It may be possible, that the digital signal processor and the processing unit constitute an integral unit.

In consequence, it is a function of the network interface, to connect device 100 into a network and to ensure a communication of the device to other elements within the network. An important embodiment of the network interface 102 is such an arrangement, that communication may be performed via diverse communication standards, such that the overlay network topology established a logic network topology, ranging over different communication channels. The established network is thus flexible concerning available communication standards. This flexibility is particular advantageous, since user is not limited to specific communication standards. An IoT setup in a residential environment or in the contest of an automated production may thus be shaped in a very flexible and long-ranging manner. In particular, it is easily possible for a user to integrate devices of diverse functionality and from different manufacturers into an individual network setup and to enlarge and adapt said network at any time

The data processing unit 104 enables the sending and/or reception of data via the network interface 102. To that aim, the data processing unit perform one of the following functions: publish, subscribe, clone, modelling, update or avatar. These functions are described above in this disclosure. In particular, the data processing unit 104 thus allows for creation of an own model of the dynamic network within the device 100 (at least of the part of the network relevant to the device 100). The integration into a relevant portion of the network is particular achieved by the publish function and the subscribe function, by which the role of the device 100 within the network is obtained. The device 100 is an autonomous actor resp. agent with the network, since the set of data published to other network elements and those data observed in the network are defined within the device 100. A network formed by elements such as the device 100 does not require any central control. In contrary, it is formed by individual autonomous agents without having a specific hierarchy. It may be flexibly and dynamically established, enlarged or adapted in a very easy manner.

Any device 100 may manage the dynamic network. To that aim, the in particular following three functions contribute: clone, modelling and update, but avatar may contribute as well. These functions are described above in this disclosure. By means of the clone function, the device 100 may copy the publish/subscribe structure of a similar device (source). Device 100 becomes a clone model of the source. This model may be changed via the modelling function, such that the role of the source within the dynamic network is adapted. In example, the source may be integrated into the dynamic network. The adapted clone model of the source existing in the device, may be adopted and implemented by the source via the update function. As result, the inter-links of the units in the dynamic network are actually changed.

The device 100 finally has a functional unit 106. This functional unit 106 may comprise an actuator, a sensor, a data generation unit or a man-machine-interface. By means of the functional unit, the device 100 may act as element of a dynamic network and not just simply as an autonomous agent. It rather may execute a specific task, as e.g. capturing or determining a specific value or performing a specific action, such as starting an electronic device by a switch, or change a specific state, e.g. as in an electrochromic glass.

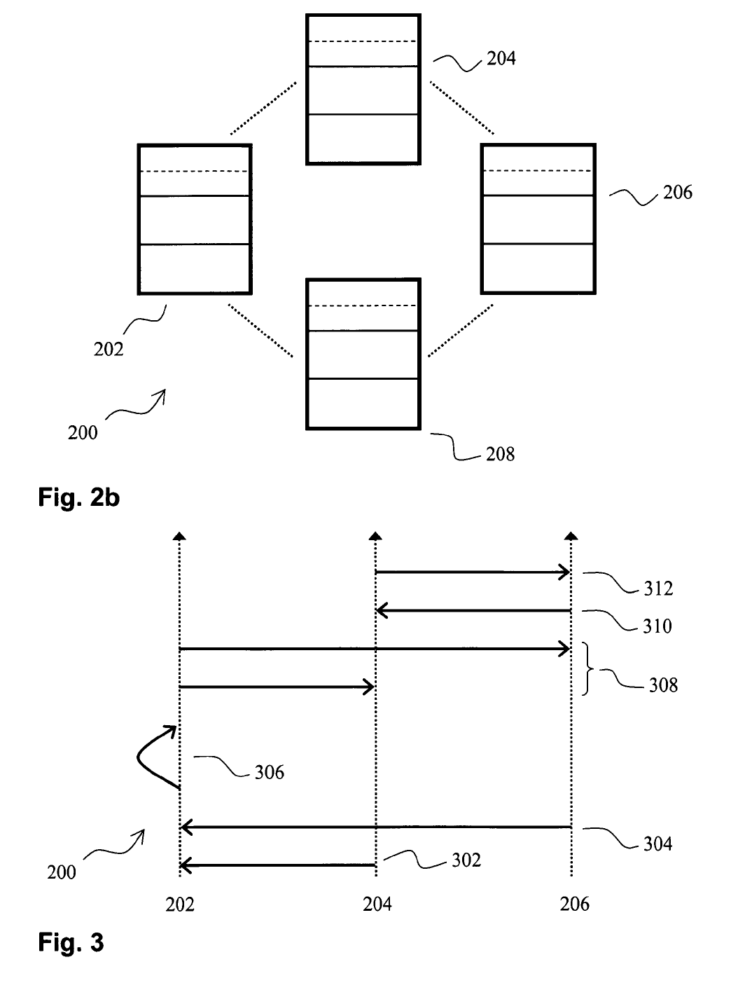

FIG. 2a shows a schematic representation of the physical structure of an embodiment of the dynamic network 200. The dynamic network 200 is composed of a first element 202, a second element 204, a third element 206 and fourth element 208. Within the depicted representation, all elements form specific electronic device, which all are embodiments of the device already discussed. The first element 202 is a smartphone. It has a network interface for integration into an overlay network topology. Thereby, the network interface may comprise a wireless interface of the smartphone and uses mobile communication standards, such as GSM, UMTS or LTE as well as data communication standards, such as Bluetooth, IrDA, and WLAN, etc. Furthermore, the network interface may comprise wireline interfaces, such as USB. Furthermore, the network interface comprises a processor unit, to ensure an integration of the smartphone into the dynamic network. The processor unit may be implemented as a software running on a microcontroller. It may as well by implemented in hardware. The network interface may be composed by individual components or at least partly by an interface block. The network interface connects to a data processing unit, typically designed as microcontroller within the smartphone. The data processing unit may be operated flexibly by firmware or software. The first element 202 further comprises a touchscreen as men-machine interface.

A bell strip constitutes the second element 204 of the dynamic network. As well, the second element 204 has a network interface for integration into an overlay network topology. The third element 204 has a data processing unit that connects to the network interface, which data processing unit is adapted to send and/or receive data via the network interface. The second element 204 has a functional unit that connects to the data processing unit. The functional unit of the second element 204 is an arbitrary number of bell pushes. Each of these may be considered as sensor, indicating if a user presses a specific bell bush.

A camera constitutes the third element 206 of the dynamic network, which element differs from the second element 204 by the functional unit. In this case, the functional unit is as well a sensor, such as a Bayer sensor for image capturing. The camera may as well comprise one or more active functional units, such as a changeable focus or a changeable zoom of a camera lens, or a servomotor to set the observed spatial angle.

A luminaire constitutes the fourth element 208 of the dynamic network, which element differs from the second element 204 and the third element 206 by the functional unit, as well. In this case, the functional unit is an actuator formed by a switch to activate or deactivate the light source of the luminaire. Again, additional active or passive functional units are possible, such as a servomotor to change the relative position of a reflector and/or an optical element towards the light source, e.g. to choose a spatial angle to be illuminated.

FIG. 2b shows a schematic representation of the overlay structure of an embodiment of the dynamic network. The overlay structure bases on a physical structure, as e.g. the physical structure shown in FIG. 2a. In particular, the overlay structure provides for the possibility of an individual address space with an individual addressing and possibly a proprietary routing scheme.

A logical structure is shown, having the first element 202, the second element 204, the third element 206 and the fourth element 208. By choosing of a suitable overlay network topology, such as Content Addressable Network (CAN), Gnutella or preferably Kademlia, the dynamic network is advantageously freely scalable, and on a logical level, a suitable routing scheme may be chosen, to communicate between two elements. The dynamic network is thus more and more independent on provided physical structures and may extend in a large space. This is particularly advantageous, if different structures are available. In the shown embodiment is possible that the second element 204, which is the bell strip, may only communicate via a Zigbee standard, while the third element 206, which is the camera, may only communicate via WLAN. It is certainly preferable to have one element within the dynamic network that functions as gateway between communication standards. That gateway may be provided for by an independent element. It is as well possible, that e.g. the second element 202, which is the smartphone, functions as gateway.

The logic level of communication via the overlay structure allows for a dynamic routing scheme, such that a communication may be set up even if individual network elements disappear by loss or failure. The system is particularly resistant, if the network contains many elements and many communication channels are available.

FIG. 3 shows a schematic representation of an exemplary communication process 300 between devices of a dynamic network according to FIG. 2a. A communication between the first element 202, which is the smartphone, the second element 204, which is the bell strip, and the third element 206, which is the camera, is shown. Communication occurs on the level of the overlay network. In relation to the exemplary communication process 300, the organization of interaction between elements within the network is described.

By a first step 302, the data model of the second element 204 is copied by means of the clone function. With the duplication, the user obtains the opportunity to obtain a view on the smartphone of the data model of the second element 204 and to introduce adaption to it, if appropriate. In a second step 304, the data model of the third element 206 is copied by means of the clone function. With the duplication, the user additionally obtains the opportunity to obtain a view on the smartphone of the data model of the third element 206 and to introduce adaption to it, if appropriate. In a third step 306, the user may produce changes to the duplications of both data models on the smartphone. E.g., the user may change the data models such that the third element 206, which is the camera, is activated by an event published by the second element 204, the bell strip, e.g. caused by the activation of a bell push. The camera may e.g. publish a recorded data stream.

Initially, all changes of the data models are performed to the duplications available in the smartphone. Only by usage of the update function in a fourth step 308, those duplications are transmitted to the second element 204 and the third element 206 to replace the existing data models. As soon as the update took place, the third element may transmit a subscribe request to the second element 204 in a fifth step 310. Thus, the second element 204 will inform the third element 206 on any change to a defined status value. If for instance, a bell push on the bell strip is activated, the change of the respective status value is published. This publication is performed in a sixth step 312, the publish step, via the dynamic network. The third element 206 retrieves the update information and may take action, such as activating the camera based on a ringing bell. In dependence of the localisation of the bell push, the positioning of the camera may be controlled accordingly, such that a specific spatial angle is captured by the optics of the camera. This may in particular as well be the case, if the camera remains activated constantly.

The process flow is non-exhaustive and publish steps of the second element 204 may occur continuously. As well, further clone steps may occur from time to time, to allow for copying the data model of the second element 204 and/or the third element 206 to another element of the dynamic network, and to perform changes, when desired. E.g. the subscribe step performed on the third element 208 may be revoked and the influence of an updating of a date of the second element 204 on actions of the third element 206 is terminated. It is as well possible, that action within the third element 206 is further influenced by the state of a date published by another element of the dynamic network. E.g., the camera may only be activated, if a brightness sensor indicates sufficient illumination of the observed spatial angle. In overall terms, this embodiment is meant to illustrate the tremendous degree of flexibility and design freedom obtained by the network according to the present disclosure. Basis to that is the device for use in the dynamic network as exemplarily shown with reference to FIG. 1, which had been described as autonomous agent within the dynamic network.

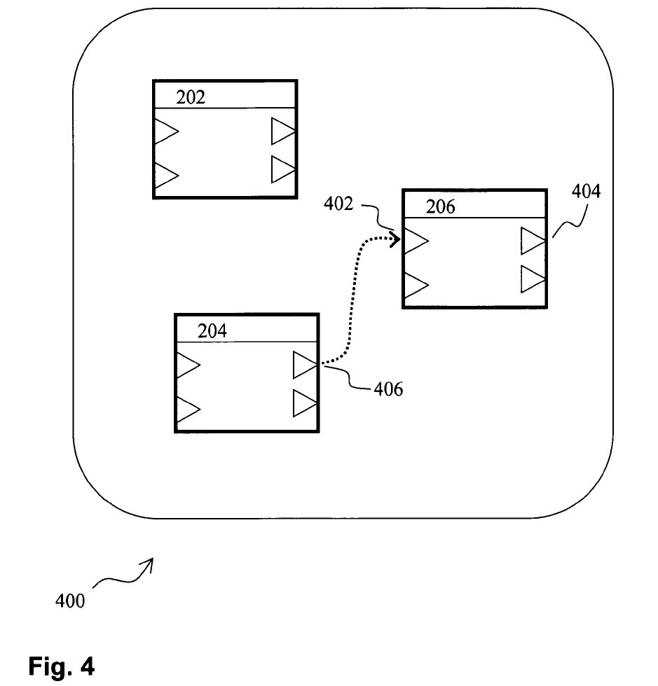

FIG. 4 shows a schematic representation of an embodiment of a user interface 400 on a man-machine interface of the first element 202 for creation installation and management of interlinks in a dynamic network with regard to the embodiment illustrated in FIG. 2a, FIG. 2b, and FIG. 3.

The user interface 400 shows the detected elements of the dynamic network. These are the first element 202, having the same user interface 400, the second element 204, i.e. the bell strip, and the third element 206, i.e. the camera. The elements are represented in such a manner, that on the respective left side all inputs for controlling an operation of the respective element are depicted, which may be initiated by data obtained over the network. On the right side, those data of the respective element are depicted, that are meant to be published in the network. This should now be explained in respect to the third element 206. The left side shows a data input 402. The data input 402 servers as trigger to an activation of the third element 206. A data output 404 is depicted on the right side. In the present example, the data output 404 indicated, whether a data streaming of the camera is activated or whether the camera is inactive.

The second element 204 has a data output 406, indicating whether a specific bell push is activated.

By means of the user interface 400, a user may influence the interoperation of the depicted elements of the dynamic network, by executing a clone step to retrieve an up-to-date copy of the data models of those elements. In a subsequent modelling step, these data models may be adapted, so to adapt the interoperability of the elements of the dynamic network. By way of example, the user may connect the data output 406 to data input 402. The following update step will induce the third element 206 to perform a subscribe step to the second element 204 and the camera function will be performed in dependence of a state change of the date published by the data output 406.

The shown embodiment is described in relation to a very simple network having three elements. The potential of the described system, the flexibility and opportunity to variably design or adapt the dynamic network, grows by the complexity of the network having a high number of elements and functions provided by these elements. In particular, this enable the user to create a control and regulating system within the dynamic network in an easy manner and to influence a provision of data in a very controlled manner.

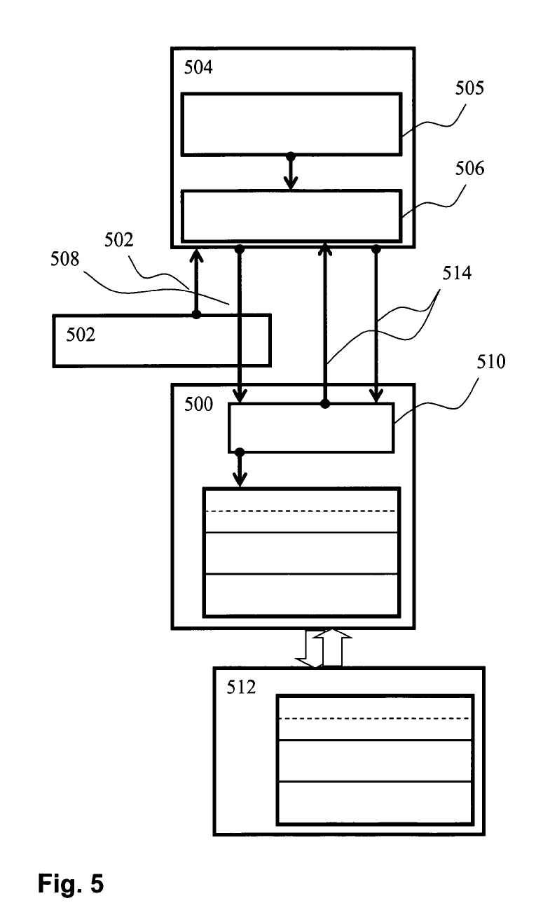

The high formability and flexibility of such a generated network require the possibility to limit access to individual elements of the network. This relates to a security aspect, allowing only authorized access to the network. Since the network has a dynamic formation, as shown bootstrapping discussed in the context of the Kademlia network topology in this document, it is advantageous to ensure for encrypted communication between network elements. In that context, an asymmetric encryption method such as public key crypto system is suitable. An example of the implementation of such a crypto system is shown in relation to FIG. 5 as follows.

FIG. 5 shows a schematic representation of method for certification of a communication between two devices for use in dynamic network.

It shows the generation of a hierarchy of certificates for encryption of digital signature of a communication of a device 500 for use in a dynamic network. Starting point is a designer tool 503 creating an original certificate. In a first step 502, the original certificate is transferred to a central certification authority 504, creating a valid hierarchy of certificates based on the original certificate, which hierarchy is formed by a certification path of certificates towards the original certificate. This certification path is provided to the design tool 502 by a certificate management 506 of the certification authority 504. In a second step 508, the design tool 502 may transfer the hierarchy of certificates to a certificate store. The certificate manager 506 obtains the hierarchy of certificates by a certificate repository 505.

The device 500 derives from the hierarchy of certificates an individual and signed identification within the network topology, such as its node ID within a Kademlia network topology. The signature of the identification is available via a public key of the device and/or a public key of the certification authority. The signed identification of the device ensures that the device may only integrated into a dynamic network certified accordingly by the certification authority 504.

The device 500 furthermore makes use of the hierarchy of certificates to transmit data to other elements of the overlay network topology, such as the second device 512. The hierarchy of certificates ensures the encryption/verification of received information within the network topology.

By an update step 514, a renewed or exchanged hierarchy of certificates may be transmitted to the device 500, whether initiated upon request of the device or triggered by the certification authority. The authentication/signing and the encryption of data sent from the device 500 to the certification authority 504 makes use of the respective applicable hierarchy of certificates.

### FINAL REMARKS

The device for use in dynamic network as well as the dynamic network had been described by various embodiments to illustrate the underlying concept of the disclosure. The embodiments are not limited to specific combinations of features. Even if some features or arrangements are only described with regard to one or more specific embodiments, it should be readily understood, that these feature might as well combine to other features of different embodiments. It is as well possible, to ignore shown features or to add specific features or arrangements, as long as the general teaching of the disclosure remains viable.

1. Device (100) having:
a network interface (102) to connect to an overlay network topology;
a data processing unit (104) connected to the network interface (102) and configured to send and/or receive data via the network interface and a functional unit (106) that connects to the data processing unit.

2. Device (100) according to claim 1 whereby the network interface (102) is configured to connect via at least a wireline or a wireless communication network.

3. Device (100) according to one of the preceding claims, whereby the data processing unit (104) is configured to receive and/or emit data via an observation pattern via the network interface (102).

4. Device (100) according to one of the preceding claims, whereby the data processing unit (104) is configured to regulate and control the functional unit (106).

5. Device (100) according to claim 4, whereby the functional unit (106) comprises an actuator unit.

6. Device (100) according to one of the proceeding claims, whereby the data processing unit (104) is configured to receive data from the functional unit (106).

7. Device (100) according to claim 6, whereby the functional unit (106) comprises a sensor unit.

8. Device (100) according to one of the proceeding claims, whereby the functional unit (106) comprises a data generation unit.

9. Device (100) according to one of the proceeding claims, whereby the functional unit (106) comprises a man-machine interface.

10. Dynamic network (200) having a first device (202) and a second device (204) according to one of the claims 1 to 9.

11. Dynamic network (200) according to claim 10, whereby the second device (204) comprises an actuator unit (110) activatable by a date received from the first device (202).

12. Dynamic network (200) according to claim 10 or claim 11, having a third device (206) whereby the third device (206) is configured to transmit from the first device (202) to the second device (204) an alteration date.

13. Dynamic network (200) according to one of claim 10 to claim 12, whereby data communication between the first device (202) and the second device (204) is encrypted by an asymmetrical encryption method.
